(19) United States
(12) Patent Application Publication
(10) Pub. No.: US 2024/0327219 A1
(43) Pub. Date: Oct. 3, 2024

(54) METHOD FOR MANUFACTURING ZINC PHOSPHATE (ZN3(PO4)2)

(71) Applicants: OCP SA, Casablanca (MA); Universite Mohamed VI Polytechnique, Benguerir (MA)

(72) Inventors: Khaoula Khaless, El Jadida (MA); Rachid Boulif, El Jadida (MA); Rachid Benhida, Nice (FR)

(73) Assignees: Universite Mohamed VI Polytechnique, Benguerir (MA); OCP SA, Casablanca (MA)

(21) Appl. No.: 18/037,908

(22) PCT Filed: Nov. 19, 2021
(86) PCT No.: PCT/MA2021/000020

§ 371 Date: Nov. 22, 2023

(30) Foreign Application Priority Data
Nov. 19, 2020 (FR) 2011908

(51) Int. Cl. C01B 25/37; B01J 19/10

(52) U.S. Cl. CPC C01B 25/37; B01J 19/10; B01J 2219/089; C01P 2002/72; C01P 2002/77; C01P 2004/03; C01P 2006/80

(57) ABSTRACT

The present disclosure relates to a method for producing zinc phosphate with the application of ultrasound having a frequency greater than 100 KHZ.

### FIELD OF THE INVENTION

The present invention relates to a method for manufacturing zinc phosphate, catalysed by ultrasound.

### BACKGROUND OF THE INVENTION

Zinc phosphate (Zn₃(PO₄)₂) is generally in the form of a white solid that is insoluble in water. It exists in nature in mineral form and can be in various more or less hydrated forms and/or complexed with other metals, forming hopeite, parahopeite, tarbuttite, phosphophyllite, etc.

Zinc phosphate is commonly used, and has been used for many years, in cement manufacture and dentistry and in many other industrial applications. One of the major advantages of zinc phosphate is that it gives materials extremely effective bonding and sealing properties. It is also known for its performance and its quick setting. It also used for its anti-corrosion properties in the protection of metal surfaces due, amongst other things, to its excellent adherence property. Hence, zinc phosphate is widely used as an anti-corrosion mineral pigment in protective coating systems. Paint manufacturers use it to produce industrial anti-corrosion paints, for example in automotive, aeronautical or marine paints [1].

Zinc phosphate is one of the derivatives of phosphate. It is formed by reaction between zinc oxide in aqueous slurry and purified phosphoric acid. At the end of the reaction, water is removed by filtration and the zinc phosphate constituting the filtrate is dried before being ground and packaged. The setting reaction is a chemical reaction between a liquid and solid. The action of phosphoric acid on zinc oxide is manifest by the formation of various hydrated phosphates. Thus, there are four types of reaction:

ZnO+2H₃PO₄→Zn(H₂PO₄)₂·H₂O

ZnO+H₃PO₄+2H₂O→ZnHPO₄·3H₂O

3ZnO+2H₃PO₄→Zn₃(PO₄)₂·2H₂O+H₂O

ZnO+2H₃PO₄+H₂O→Zn₃(PO₄)₂·4H₂O

The compound Zn₃(PO₄)₂·4H₂O, also called hopeite, exists in two allotropic forms, α and β, with extremely similar space group Pnma, lattice parameters and crystalline structures, the only differences being the position of the hydrogen atoms which induces birefringence and distinct surface charges for the two compounds [1, 6]. However, whatever the allotropic form, hopeite has a limited ability as a function of temperature. Indeed, the material starts to dehydrate at 70° C. [2]. Hopeites of form α and β have exactly the same dehydration mechanisms at the same temperatures. The first step starts at around 70° C. and has a critical temperature T1/2 of 120° C. It is manifest by loss of two water molecules in order to obtain a product of formula Zn₃(PO₄)₂·2H₂O. The last step at around 300° C. is due to the loss of the last two molecules of water in order to obtain an anhydrous product of formula Zn₃(PO₄)₂ [2].

The structure of hopeite and the details of the zinc coordination polyhedra in the structure are shown in FIG. 1.

Hopeite consists of sequences of [ZnO₄] and [PO₄] tetrahedra and [ZnO₂(H₂O)₄] octahedra. The structure can be represented as the alternating of three planes respectively consisting of [ZnO₂(H₂O)₄] (denoted O) octohedra, [ZnO₄] (denoted Z) and [PO₄] (denoted P) tetrahedra in the direction b, by repetition of the pattern O—P—Z—P. The lattice parameters of α and β hopeites and of the dehydrated product obtained after the first dehydration, are presented in table 1.

TABLE 1
Lattice parameters for hopeite α and β and the compound Zn₃(PO₄)₂•2H₂O [2]

| Paramètres | αZn₃(PO₄)₂•4H₂O | βZn₃(PO₄)₂•4H₂O | Zn₃(PO₄)₂•2H₂O |
|---|---|---|---|
| G.E. | Pnma | Pnma | P2₁/c |
| a (Å) | 10.629(2) | 10.6060(4) | 10.451(7) |
| b (Å) | 18.339(3) | 18.2946(5) | 5.036(3) |
| c (Å) | 5.040(1) | 5.0266(2) | 31.437(15) |
| Angle β | 90° | 90° | 92.46° |

| French | English |
|---|---|
| Paramètres | Parameters |
| G.E. | S.G. (Space group) |

At temperatures greater than 300° C., hopeite dehydrates entirely and gives an anhydrous orthophosphate of formula Zn₃(PO₄)₂. According to the literature, zinc orthophosphate has three monoclinic allotropic varieties: α, β and γ [2]. Two phases are stable at ambient temperature: these are the α and γ phases. The β phase reversibly transitions to the β phase at 965° C. and it should be noted that the β phase can only be observed at ambient temperature after rapid quenching. The space group and the lattice parameters of the three structures α, β and γ Zn₃(PO₄)₂, are given in table 1. The crystalline structures of the phases are given in FIG. 2. The zinc coordination polyhedra are shown in green, and those of phosphorus in violet.

Various methods have been proposed for producing zinc phosphate.

U.S. Pat. No. 2,407,301 [3] describes a method based on the treatment of zinc oxide with phosphoric acid in an aqueous medium at a temperature ranging from 70° C. to 80° C. in the presence of metallic zinc in a quantity ranging from 1 to 10% by weight of zinc oxide, followed by separation of the resulting residue of zinc phosphate. The yield of zinc phosphate is 98%. The method makes it possible to produce zinc phosphate ensuring high protective and physico-mechanical properties of coatings.

Zinc phosphate has been synthesised by S. Rameshet et al. [4] by another method comprising the addition of orthophosphoric acid to a zinc acetate solution under constant stirring, followed by the addition of hydrazine hydrate to the solution obtained, under stirring for 3 hours. The white precipitate obtained is filtered and washed with water, then with ethanol in order to remove organic impurities. The precipitate is then calcined in a muffle furnace for 24 hours at 300° C. The morphology and optical properties were studied by XRD, SEM, TEM, FTIR and Raman spectroscopy.

CN 1164508 [5] proposes another method for producing zinc phosphate. The zinc oxide used has a lower degree of quality (purity varying from 50% to 95%) and the phosphoric acid comes from liquid-liquid extraction. The reaction temperature varies from 70 to 90° C., the reaction time varies from 40 to 60 minutes and the stirring speed varies from 4 to 6 revolutions/sec. EP0009175 A1 proposes a method for manufacturing zinc phosphate, of formula Zn₃(PO₄)₂·nH₂O (n=0 to 4), through a reaction between zinc oxide (20-85% by weight) and phosphoric acid (10 to 50% by weight) at a temperature varying from 10 to 100° C., at a stirring speed varying from 3000 to 10,000 rpm. Zinc oxide and high-purity phosphoric acid (membrane method) were used in a molar ratio of 1.5 in order to avoid an acid pH in the reaction mixture, this reaction being followed by separating and drying of the end product. This method has made it possible to produce zinc phosphate having high protective, physico-chemical and mechanical properties, as a constituent of paint coating based on synthetic binders. The yield obtained is ≥98%.

Hence, even though various methods are known for producing zinc phosphate, there is still a need for the provision of a simple, efficient and economic method (low investment and operating costs) for manufacturing high-purity zinc phosphate at ambient temperature.

### BRIEF DESCRIPTION OF THE INVENTION

The present invention relates to a method for producing zinc phosphate comprising a step consisting of reacting zinc oxide with phosphoric acid, preferably purified industrial phosphoric acid, under the action of ultrasound having a frequency greater than 100 KHz. Other aspects of the invention are as described below and in the claims.

### FIGURES

FIG. 1: Structure of hopeite α [1].

FIG. 2: Crystal structure of the α, β and γ phases of Zn₃ (PO₄)₂.

FIG. 3: X-ray diffraction diagram, (Zn₃(PO₄)₂·4H₂O) at 20° C. obtained according to example 2.

FIG. 4: SEM image of zinc phosphate (Zn₃(PO₄)₂) obtained according to example 2 (A: magnification X259; B: magnification X1000; C: magnification X2000; D: magnification X3084).

FIG. 5: X-ray diffraction diagram, Zn₃(PO₄)₂·2H₂O, Zn₃(PO₄)₂·4H₂O and ZnO at 20° C., obtained according to comparative example 1.

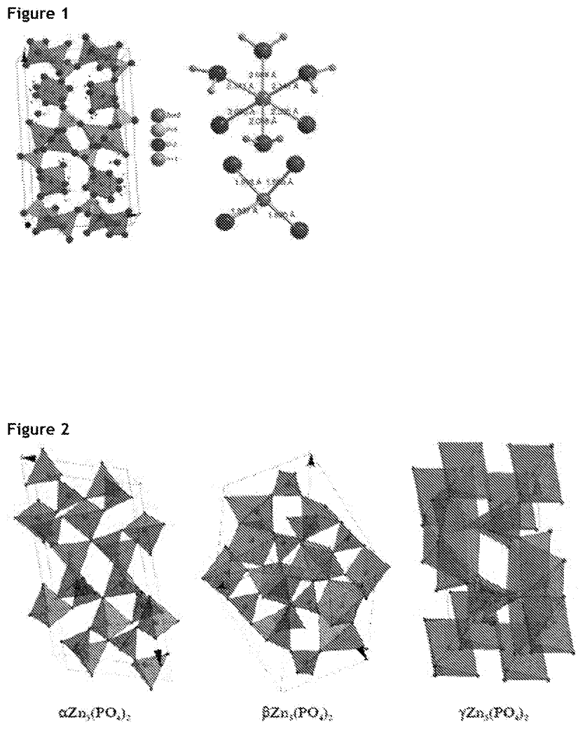

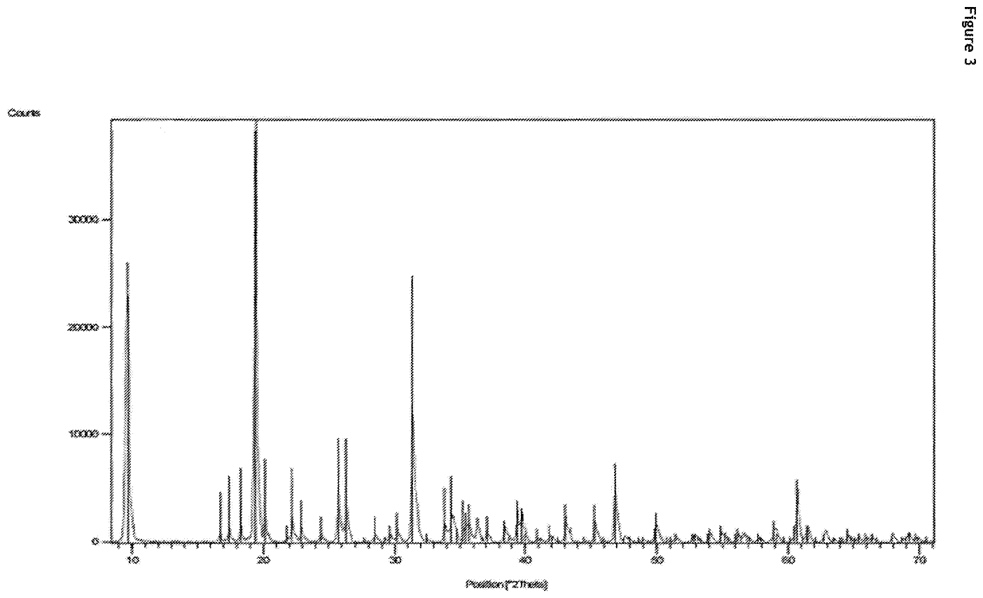

### DETAILED DESCRIPTION OF THE INVENTION

The present invention relates to a method for producing zinc phosphate, more particularly zinc phosphate having a high purity (≥98%), from phosphoric acid, more particularly from a purified industrial phosphoric acid, under the action of high-frequency ultrasound.

Ultrasound involves sinusoidal acoustic waves, the frequency range of which are between 16 kHz and 10 MHz. The unit of measurement for ultrasound is the Hertz (Hz). Several decades ago, the use of ultrasound in chemistry was a mere curiosity. The concept of acoustic cavitation was not well-known in the field of applied chemistry. With the high price of organic reagents and their often-toxic properties, the use of ultrasound became an interesting route for reducing the use of reagents and reaction times.

The inventors of the present invention, who benefit from long experience in the activation of chemical reactions by ultrasound, as demonstrated by a collection of articles in this field [7-11], have thus developed a simple and efficient method for producing zinc phosphate from phosphoric acid, in particular from purified industrial phosphoric acid, through a reaction, typically at ambient temperature, under ultrasonic activation.

Thus, the method for producing zinc phosphate of the present invention comprises a step consisting of reacting zinc oxide with phosphoric acid under the action of ultrasound having a frequency greater than 100 kHz and typically less than 1 MHZ.

Ultrasound having a frequency greater than 100 kHz and less than 1 MHz is designated in the present description by the expression “high-frequency ultrasound”.

The zinc oxide used in the method of the present invention is typically in the form of particles. The size of the particles is not limiting and will typically be chosen according to the intended applications. In certain embodiments, the particle size of zinc oxide ranges from 0.1 to 5 μm. In certain embodiments, 90% by number of the particles have a size ranging from 0.1 to 5 μm. Particles having a size ranging from 0.1 to 5 μm enable the chemical yield of the reaction to be increased. Such particles can result from the grinding of zinc oxide. Thus, in certain embodiments, the method for producing zinc phosphate of the present invention can comprise a prior step of grinding zinc oxide in order to obtain particles of size ranging from 0.1 to 5 μm. The grinding can be carried out by strong crushing. Refining, carried out using a sieve, makes it possible to then select particles for which the size ranges from 0.1 to 5 μm. The size of the particles can be measured by laser particle size analysis. The zinc oxide can be a technical grade zinc oxide (purity ranging from 97% to 98%). Its physico-chemical characteristics are as follows: Zn-77, 14%; Pb 5 ppm; Cu 5 ppm, Cd 20 ppm, Fe 50 ppm and Mn 5 ppm.

The zinc oxide used in the context of the present invention can be extracted from minerals or can come from industrial waste.

The phosphoric acid used in the method of the present invention is typically a pure phosphoric acid, in other words a phosphoric acid having a purity of 99.99%, such as a purified industrial phosphoric acid. Such a purity level of phosphoric acid enables the preparation of very high purity zinc phosphate. The purified industrial phosphoric acid can the obtained via a wet process of liquid-liquid extraction or by membrane filtration or from a thermal process. The phosphoric acid is generally a phosphoric acid comprising 5 to 65% P₂O₅ (equivalent to 6.9 to 89.7% H₃PO₄), preferably 10 to 61% P₂O₅ (equivalent to 13.8 to 84.18% H₃PO₄). In certain embodiments, phosphoric acid comprises 10 to 61% P₂O₅, preferably 45 to 61% P₂O₅. The phosphoric acid used can come from the action of a strong acid, such as hydrochloric acid, nitric acid or sulfuric acid, on natural phosphate followed, by purification using a membrane method.

The phosphoric acid can be as produced by the Jorf Lasfar industrial site of the OCP group, Morocco. The concentration of phosphoric acid in P₂O₅ is 61.6%, equivalent to 85% H₃PO₄.

The proportions of zinc oxide and phosphoric acid used in the method of the present invention are typically such that the mass ratio of phosphoric acid:zinc oxide (H₃PO₄:ZnO) is greater than or equal to 0.3. Advantageously, the ratio of phosphoric acid:zinc oxide ranges from 0.3 to 2, preferably from 0.5 to 2, still more preferably from 0.8 to 1.5.

The zinc oxide is typically added to the phosphoric acid gradually, in other words progressively so as to maintain a homogeneous mixture and avoid the formation of agglomerates. The assembly is stirred in order to homogenise the mixture. The homogenisation time typically ranges from 1 minute to 90 minutes, preferably 5 minutes to 60 minutes, or even 5 minutes to 35 minutes.

The reaction is typically carried out in a reactor.

The high-frequency ultrasound catalyses the reaction. The use of high-frequency ultrasound is beneficial, since it enables homogenisation of the solution: it enables the zinc oxide to dissolve entirely and a stable and homogeneous gel to be obtained. The use of high-frequency ultrasound also enables an increase in the reaction speed and consequently a reduction in the reaction time, a reduction in energy consumption, with the possibility of reducing the amount of reactant added.

High-frequency ultrasound is typically applied for a duration of less than 30 minutes. The duration of application or ultrasound typically ranges from 1 to 30 minutes, preferably from 5 to 15 minutes. It is nevertheless understood that high-frequency ultrasound can be applied for a duration greater than 30 minutes.

Advantageously, high-frequency ultrasound can reduce the reaction time by a factor ranging from 6 to 10 for an identical yield.

High-frequency ultrasound involves sinusoidal acoustic waves, the frequency range of which is between 100 kHz and 1 MHz. The waves are characterised by a frequency expressed in Hz and a power expressed in W.

The high frequency ultrasound used in the present invention preferably ranges from 100 to 500 kHz, or even from 100 to 200 kHz; typically it is 170 KHz.

The power density of the high-frequency ultrasound used in the present invention typically ranges from 100 to 2000 W, preferably from 100 to 1000 W, typically it is 1000 W. The optimum power density is 1000 W at 170 KHz.

The high-frequency ultrasound can be applied by means of an ultrasound bath, for example by immersion of the reaction medium, more exactly of the reactor containing zinc oxide and phosphoric acid, in an ultrasound bath or by means of an ultrasound probe, typically by immersing an ultrasound probe in the reaction medium.

In certain embodiments, high-frequency ultrasound is applied in an ultrasound bath at 170 kHz, the power density of which is 1000 W. The ultrasonic waves thus activate the reaction. It has been shown that the higher the frequency, the higher the rate of zinc phosphate production induced by the high-frequency ultrasound, for a given power. The ultrasound frequency therefore has a significant influence and is controlled according to the quality of the desired product.

The product obtained is typically washed, in order to remove residual phosphoric acid, and dried. Washing is generally carried out with distilled water. The drying step is typically carried out at a temperature ranging from 40 to 100° C., preferably from 50 to 80° C. The drying is typically carried out in an oven.

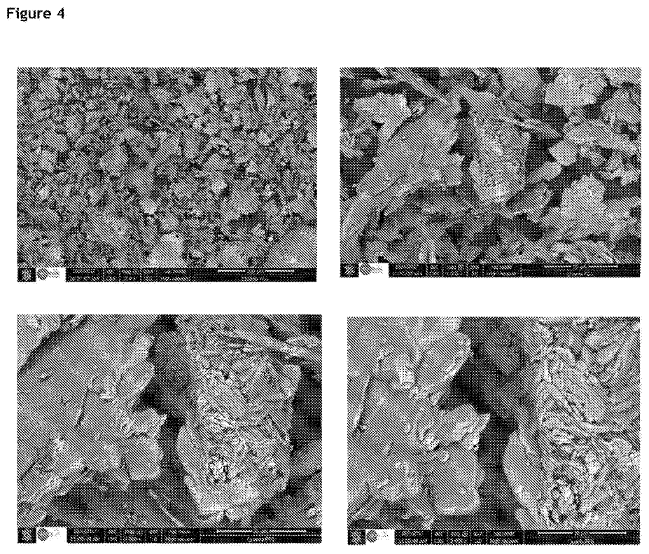

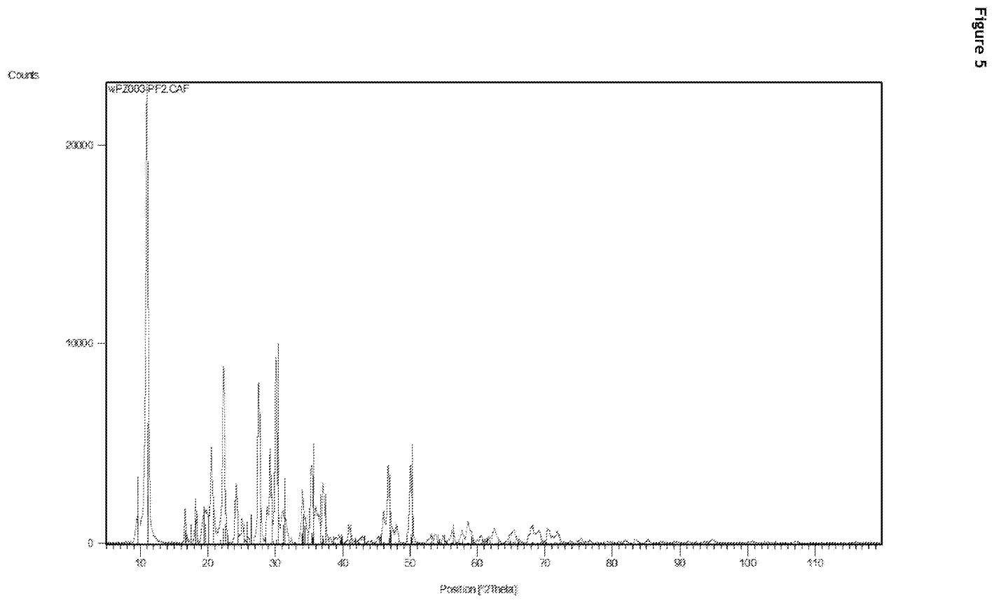

The oven drying is carried out at a temperature enabling the fastest possible drying while preserving the quality of the crystal compound. At the end of this drying, zinc phosphate in solid form is obtained. It has a grey colour. Its quality can be analysed by the usual chemical analysis methods, such as x-ray diffraction (XRD), scanning electron microscopy (SEM), etc. Observation using a scanning electron microscope (SEM) coupled with energy dispersive x-ray analysis (EDAX) has shown that the zinc phosphate Zn₃(PO₄)₂·4H₂O obtained by the method of the present invention substantially consists of phosphate particles that are square-shaped, rectangular or crystals in the form of an irregularly shaped sheet (FIG. 4). The chemical analyses have shown that the product obtained by the method of the present invention (Zn₃(PO₄)₂·4H₂O) comprises 65% by weight Zn and 31% by weight PO₄.

The product is obtained with a good yield, typically greater than 98%, and has a high purity (≥98%). The high frequencies can also enable the product to be obtained with a yield and a purity greater than 99%.

The zinc phosphate obtained by the method of the present invention can be used as paint pigment, adhesive agent, anti-corrosion agent, trace element, additive in various fertiliser matrices, cement manufacture and in dental applications, etc.

The present invention also relates to a method comprising the production of a solid phase with a liquid phase, said method comprising the following steps:
(a) producing a solid phase by grinding a solid to 0.1-5 μm;
(b) introducing a liquid phase, at a first flow rate, into a mixing reactor;
(c) introducing the solid phase obtained in step (a), at a second flow rate, into said reactor;
(d) mixing the solid phase with the liquid phase, under mechanical stirring, in said reactor;
(e) conveying the mixture into an ultrasound bath having a power of 1000 W;
(f) applying ultrasound at 170 kHz in the ultrasound bath;
(g) washing the precipitate obtain with distilled water and drying at 60° C. for 4 hours.

Such a method can be used for the production of phosphate salts.

### EXAMPLES

### Equipment

An ultrasound bath (1000 W, model BT90H) from Ultrasonic Power Corporation, Freeport, Illinois (USA) in combination with a 170 kHz Ultrasound generator (Ultrasonic Power Corporation) was used in examples 2 and 3 below.

### Comparative Example 1: Manufacture of Zinc Phosphate without Ultrasound

In this example, the production of zinc phosphate was carried out according to the following steps:
producing zinc oxide by grinding to 0.1-5 mm (solid phase);
sending phosphoric acid 61% P₂O₅ into a mixing reactor (liquid phase);
sending zinc oxide, at a second flow rate, into the reactor with a mass ratio ZnO/H₃PO₄ equal to 1;
mixing the solid phase with the liquid phase in the reactor, under stirring, for 30 minutes;
washing the white precipitate obtained with distilled water and drying at 60° C. for 4 hours.

The product obtained is in the form of a grey powder. This powder is not a pure product; more specifically, it contains a certain proportion of other compounds from the initial mixture. The results of the physical analysis by XRD presented in FIG. 5 show that the final product contains a three-phase mixture (Zn₃(PO₄)₂·2H₂O, Zn₃(PO₄)₂·4H₂O, ZnO). The final product is impure.

### Example 2: Method for Manufacturing Zinc Phosphate Including a Step of Activation by Ultrasound

Zinc phosphate was prepared using a similar method to that of example 1, but comprising a step of applying high-frequency ultrasound. The method comprises the following steps:
grinding zinc oxide to 0.1-5 μm (solid phase);
sending phosphoric acid 61% P₂O₅ into a mixing reactor (liquid phase);
sending zinc oxide, at a second flow rate, into the reactor with a mass ratio ZnO/H₃PO₄ equal to 1;
mixing the solid phase with the liquid phase in the reactor, while stirring for 30 minutes;
activating the mixture with ultrasound, with an optimal power used at 170 kHz for 10 minutes (1000 W);
washing the white precipitate obtained with distilled water and drying at 60° C. for 4 hours.

The mixture is homogeneous, it appears uniform to the eye and to the hand (absence of caking due to the ultrasound, uniform particle size). The observations under the microscope show a homogeneous compound with separated grains. The physical analysis by XRD, titration and chemical analyses showed that the product obtained by including an ultrasonic activation step is pure and that in the composition of Zn₃(PO₄)₂·nH₂O, n depends on the temperature and the crystallisation time (FIG. 3).

The x-ray diffraction diagram (FIG. 3) shows a result obtained for the mixture of technical grade phosphoric acid and zinc oxide, catalysed by ultrasound. This mixture was dried at 60° C. until stability of the final mass. The final product is indeed zinc phosphate of chemical formula: Zn₃(PO₄)₂·4H₂O.

We have confirmed the good reproducibility of this method for producing Zn₃(PO₄)₂·4H₂O. The XRD analyses have shown that the product obtained is pure. The yield of the reaction is greater than 99%.

### Example 3: Influence of the Stirring Time

Zinc phosphate was prepared by a method similar to that of example 2, in which the stirring time was reduced. The method comprises the following steps:
grinding zinc oxide to 0.1-5 μm (solid phase);
sending phosphoric acid 61% P₂O₅ into a mixture reactor (liquid phase);
sending zinc oxide, at a second flow rate, into the reactor with a mass ratio ZnO/H₃PO₄ equal to 1;
mixing the solid phase with the liquid phase in the reactor, under stirring for 10 minutes;
activating the mixture with ultrasound, with an optimal power used at 170 kHz for 10 minutes (1000 W);
washing the grey precipitate obtained with distilled water and drying at 60° C. for 4 hours.

The physical analyses by XRD, complexometric titration and chemical analyses have shown that a pure product is obtained by reducing the stirring time.

### REFERENCES

[1] Zhang Jun, Jiang Fengzhi, (preparation of zinc phosphate by liquid-liquid heterogeneous reaction), patent No. CN 1164508 A.
[2] F. Rodriguez, D. Hernandez, J. Garcia-Jaca, H. Ehrenberg and H. Weitzel, (Optical study of the piezochromic transition in CuMoO₄ by pressure spectroscopy), Physical Review B, Vol. 61, Number 24, 2000, 16497-16501
[3] Natalia E Danjushevskaya, Process for producing zinc phosphate. U.S. Pat. No. 4,207,301A. 1980.
[4] S. Ramesh and V. Narayanan, synthesis and characterisation of zinc phosphate nanoparticles by precipitation method. Print version ISSN 2347-3207.
[5] Zhang Jun, Jiang Fengzhi, preparation of zinc phosphate by liquid-liquid heterogeneous reaction. Patent No. CN 1164508 A.
[6] S. Mallouk, K. Bougrin, H. Doua, R. Benhida, M. Soufiaoui. Ultrasound-accelerated aromatisation of trans- and cis-pyrazolines under heterogeneous conditions using claycop. Tetrahedron Lett. 2004, 45, 4143-4148
[7] M. Driowya, A. Puissant, G. Robert, P. Auberger, R. Benhida, K. Bougrin. Ultrasound-assisted one-pot synthesis of anti-CML nucleosides featuring 1,2,3-triazole nucleobase under iron-copper catalysis. Ultrasonics Sonochem. 2012, 19, 1132-1138
[8] H. Marzag, G. Robert, M. Dufies, K. Bougrin, P. Auberger, R. Benhida. FeCl₃-promoted and ultrasound-assisted synthesis of resveratrol O-derived glycoside analogs. Ultrason. Sonochem. 2015, 22, 15-21.
[9] H. Marzag, S. Alaoui, H. Amdouni, A. Martin, K. Bougrin, R. Benhida. Efficient and selective azidation of per-O-acetylated sugars using ultrasound activation: Application to the one-pot synthesis of 1,2,3-triazole glycosides. New. J. Chem. 2015, 5437-5444
[10] S Alaoui, M Driowya, L Demange, R Benhida, K Bougrin. Ultrasound-assisted facile one-pot sequential synthesis of novel sulfonamide-isoxazoles using cerium (IV) ammonium nitrate (CAN) as an efficient oxidant in aqueous medium. Ultrason Sonochem. 2018; 40, 289-297.

1. A method for producing zinc phosphate comprising a step consisting of reacting zinc oxide with phosphoric acid, under the action of ultrasound having a frequency greater than 100 kHz.

2. The method according to claim 1, wherein zinc oxide is added gradually to phosphoric acid under stirring, before applying ultrasound.

3. The method according to claim 2, wherein the stirring duration before applying ultrasound ranges from 1 to 90 minutes.

4. The method according to claim 1, further comprising a step of washing and drying the product obtained at the end of the reaction of zinc oxide with phosphoric acid.

5. The method according to claim 1, further comprising a step of washing and drying the product obtained at the end of the reaction of zinc oxide with phosphoric acid and wherein the drying is carried out at a temperature ranging from 40 to 100° C.

6. The method according to claim 1, wherein the mass ratio of phosphoric acid:zinc oxide is greater than or equal to 0.3.

7. The method according to claim 1, wherein the zinc oxide is in the form of particles, the size of which ranges from 0.1 to 5 μm as measured by laser particle size analysis.

8. The method according to claim 1 comprising, beforehand, a step of grinding zinc oxide in order to obtain particles, the size of which ranges from 0.1 to 5 μm as measured by laser particle size analysis.

9. The method according to claim 1, wherein the phosphoric acid comprises 5 to 65% P₂O₅.

10. The method according to claim 1, wherein the ultrasound frequency ranges from 100 to 500 kHz.

11. The method according to claim 1, wherein the ultrasound is applied at a power density ranging from 100 to 2000 W.

12. The method according to claim 1, wherein the ultrasound frequency is 170 kHz at a power density of 1000 W.

13. The method according to claim 1, wherein the ultrasound is applied by means of an ultrasound bath or an ultrasound probe.

14. The method according to claim 1, wherein the zinc phosphate has a purity greater than or equal to 98%.

15. The method according to claim 1, wherein the duration of application of ultrasound is less than 30 minutes.

16. The method according to claim 1, wherein the phosphoric acid is purified industrial phosphoric acid.

17. The method according to claim 2, wherein the stirring duration before applying ultrasound ranges from 5 to 35 minutes.

18. The method according to claim 1, further comprising a step of washing and drying the product obtained at the end of the reaction of zinc oxide with phosphoric acid and wherein the drying is carried out at a temperature ranging from 50 to 80° C.

19. The method according to claim 1, wherein the ultrasound frequency ranges from 100 to 200 kHz.

20. The method according to claim 1, wherein the ultrasound is applied at a power density ranging from 100 to 1000 W.
